(19) United States
(12) Patent Application Publication
(10) Pub. No.: US 2026/0255283 A1
(43) Pub. Date: Aug. 27, 2026

(54) MAXIMUM POWER REDUCTION DETERMINATION AND INDICATION

(71) Applicant: Lenovo (United States) Inc., Morrisville, NC (US)

(72) Inventor: Colin Frank, Park Ridge, IL (US)

(73) Assignee: Lenovo (United States) Inc., Morrisville, NC (US)

(21) Appl. No.: 19/464,545

(22) Filed: Jan. 29, 2026

(51) Int. Cl. H04W 52/36

(52) U.S. Cl. CPC H04W 52/367

(57) ABSTRACT

Various aspects of the present disclosure relate to maximum power reduction (MPR) indication based on an error vector magnitude (EVM). An apparatus, such as a network equipment (NE), determines an MPR value for a user equipment (UE), where the MPR value satisfies an EVM requirement. The NE transmits an indication of the determined MPR value to the UE and the UE performs transmissions using the MPR value.

### TECHNICAL FIELD

The present disclosure relates to wireless communications, and more specifically to a maximum power reduction (MPR) determination and indication.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies, including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive, from an NE, an indication of an MPR value, where the MPR value satisfies an error vector magnitude (EVM) requirement, and perform a transmission using the MPR value.

A processor (e.g., a standalone processor chipset, or a component of a UE) for wireless communication is described. The processor may be configured to, capable of, or operable to perform one or more operations as described herein. For example, the processor may be configured to, capable of, or operable to receive, from an NE, an indication of an MPR value, where the MPR value satisfies an EVM requirement, and perform a transmission using the MPR value.

A method performed or performable by a UE for wireless communication is described. The method may include receiving, from an NE, an indication of an MPR value, where the MPR value satisfies an EVM requirement, and performing a transmission using the MPR value.

In some implementations of the UE, the processor, and the method described herein, the MPR value is a maximum of a set of MPR values that satisfy an emissions requirement and the EVM requirement. In some implementations, the set of MPR values includes a first MPR value that satisfies the EVM requirement, the first MPR value associated with an advanced receiver of the NE. In some implementations, the emissions requirement includes a co-existence emissions requirement, and the set of MPR values includes a second MPR value that satisfies the co-existence emissions requirement. In some implementations, the emissions requirement includes one or more in-band emissions requirements, and the set of MPR values includes a third MPR value that satisfies the one or more in-band emissions requirements.

In some implementations, the MPR value is based on an increase of a transmission power of the UE until an EVM value exceeds the EVM requirement. In some implementations, the UE, the processor, and the method may further be configured to, capable of, or operable to receive an indication of a transmission mode, a modulation type, a modulation and coding scheme (MCS) associated with the modulation type, and a resource block (RB) allocation, receive an indication of a power reduction to satisfy the EVM requirement, the power reduction based on the modulation type, receive a power control command that instructs the UE to increase the transmission power by steps in accordance with the MPR value and the EVM requirement, and increase the transmission power based on the power control command.

In some implementations, the UE, the processor, and the method may further be configured to, capable of, or operable to transmit an indication of a UE capability to satisfy the EVM requirement with an advanced receiver of the NE and the MPR value. In some implementations, the UE, the processor, and the method may further be configured to, capable of, or operable to linearize a power amplifier (PA) of the UE, where the MPR value is based on the linearization of the PA.

An NE (e.g., a base station, a gNB) for wireless communication is described. The NE may be configured to, capable of, or operable to perform one or more operations as described herein. For example, the NE may be configured to, capable of, or operable to determine an MPR value for a UE, where the MPR value satisfies an EVM requirement, and transmit, to the UE, an indication of the MPR value.

A processor (e.g., a standalone processor chipset, or a component of an NE) for wireless communication is described. The processor may be configured to, capable of, or operable to perform one or more operations as described herein. For example, the processor may be configured to, capable of, or operable to determine an MPR value for a UE, where the MPR value satisfies an EVM requirement, and transmit, to the UE, an indication of the MPR value.

A method performed or performable by an NE (e.g., a base station) for wireless communication is described. The method may include determining an MPR value for a UE, where the MPR value satisfies an EVM requirement, and transmitting, to the UE, an indication of the MPR value.

In some implementations of the NE, the processor, and the method described herein, the MPR value is a maximum of a set of MPR values that satisfy an emissions requirement and the EVM requirement. In some implementations, the set of MPR values includes a first MPR value that satisfies the EVM requirement, the first MPR value associated with an advanced receiver of the NE. In some implementations, the emissions requirement includes a co-existence emissions requirement, and the set of MPR values includes a second MPR value that satisfies the co-existence emissions requirement. In some implementations, the emissions requirement includes one or more in-band emissions requirements, and the set of MPR values includes a third MPR value that satisfies the one or more in-band emissions requirements.

In some implementations, to determine the MPR value, the NE, the processor, and the method may further be configured to, capable of, or operable to increase a transmit power of the UE and measure an EVM value until the EVM value exceeds the EVM requirement. In some implementations, the MPR value is associated with an advanced receiver of the NE, and to determine the MPR value, the NE, the processor, and the method may further be configured to, capable of, or operable to select a transmission mode, select a modulation type, an MCS associated with the modulation type, and an RB allocation, transmit, to the UE, an indication of the transmission mode, the modulation type, the MCS, and the RB allocation, transmit, to the UE, an indication of a power reduction to satisfy the EVM requirement based on the modulation type, transmit, to the UE, a power control command that instructs the UE to increase a transmission power by steps in accordance with the MPR value and the EVM requirement, determine whether the EVM requirement is satisfied in response to each step increase in the transmission power, and determine the MPR value, where the MPR value corresponds to a maximum transmission power for which the EVM requirement is satisfied.

In some implementations, the NE, the processor, and the method may further be configured to, capable of, or operable to receive an indication of a UE capability to satisfy the EVM requirement with an advanced receiver of the NE and the MPR value. In some implementations, the MPR value is determined based on a linearization of a PA of the UE.

### BRIEF DESCRIPTION OF THE DRAWINGS

FIG. 1 illustrates an example of a wireless communications system in accordance with aspects of the present disclosure.

FIGS. 2 and 3 illustrate examples of MPR determination frameworks in accordance with aspects of the present disclosure.

FIG. 4 illustrates an example of a signaling diagram in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

### DETAILED DESCRIPTION

In a wireless communications system, a user equipment (UE) and a network equipment (NE) (e.g., a base station, a gNB) may support transmission and reception of signaling, referred to as wireless communication. When the UE transmits signals to the NE, the UE may be required to satisfy various emissions requirements, including coexistence requirements (e.g., adjacent channel leakage ratio (ACLR), spectral emissions mask (SEM), spurious emissions), in-band emissions requirements, and EVM requirements. An EVM requirement may be a measure of the quality of the transmitted signal, representing the difference between a reference waveform and a measured waveform. Different modulation types have associated EVM requirements, with higher-order modulations such as 64 quadrature amplitude modulation (64 QAM) and 256 QAM requiring lower EVM values (e.g., 8% for 64 QAM and 3.5% for 256 QAM) compared to lower-order modulations such as quadrature phase shift keying (QPSK) (e.g., 17.5%). In some cases, the UE may reduce its maximum output power by an MPR value to satisfy such emissions requirements. The MPR value may depend on a modulation type and an RB allocation, with higher-order modulations requiring larger MPR values. For 64 QAM and 256 QAM, for example, the EVM requirement may be an emissions requirement that limits transmit power, resulting in significant MPR values (e.g., 3.5 decibels (dB) for 64 QAM and 6.5 dB for 256 QAM with cyclic prefix orthogonal frequency division multiplexing (CP-OFDM)). These relatively larger MPR values may reduce the cell coverage for higher-order modulations, limiting the portion of the cell where these modulations may be used and thereby reducing system throughput.

In some cases, the use of an advanced receiver at the NE may allow EVM requirements for 64 QAM and 256 QAM for a UE transmitter to be relaxed. As described herein, an advanced receiver may be a receiver implementation at the NE that differs from a reference receiver that the NE uses for an existing EVM. If the EVM requirement is an emissions requirement that limits transmit power for 64 QAM and 256 QAM, relaxation of the EVM requirement may also allow for reduction of the MPR for such modulations. As a result, the UE may use some modulations (e.g., 64 QAM and 256 QAM) over a larger portion of the cell to increase system throughput. However, UEs may lack methods for determining an EVM relaxation if the advanced receiver at the NE is unknown, and consequently, may be unable to determine a corresponding MPR reduction. Additionally, while the advanced receiver may enable a relaxation of the EVM requirement, the advanced receiver may have no impact on the coexistence and in-band emissions requirements. As such, the NE may determine an MPR value that satisfies the EVM requirement while ensuring that the other emissions are still satisfied as well. Additionally, the mapping between an EVM measured at the advanced receiver and the relaxed EVM at the UE may be complicated by factors including the difference between conductive measurements at the UE and radiated measurements at the NE, a PA implementation at the UE (e.g., average power tracking (APT), envelope tracking (ET), digital pre-distortion (DPD)), and antenna coupling in multi-antenna transmission modes.

As described herein, to address the challenges of determining MPR values when an NE uses an advanced receiver, a UE and an NE may support determination and indication of an MPR value based on an EVM requirement. Specifically, the NE may determine an MPR value for the UE that satisfies an EVM requirement and transmit an indication of the MPR value to the UE. In some examples, the MPR value may be based on an MPR reduction, which may be applied for higher-order modulation schemes such as 64 QAM and 256 QAM when the NE uses an advanced receiver. As described herein, the advanced receiver may be a receiver implementation at the NE that differs from a reference receiver the NE uses for an existing (e.g., current) EVM. The described techniques enable the NE to determine the MPR value that satisfies the EVM requirement even if the advanced receiver is undefined. Additionally, the NE may determine and indicate the MPR value even if the NE performs radiated measurements while the UE performs a conductive measurement of the EVM. As the advanced receiver may not impact coexistence emissions requirements and in-band emissions requirements, the NE may ensure that any reduction in the MPR still satisfies such emissions restraints. For example, the NE may determine separate MPR values for the different requirements (e.g., the EVM, the coexistence emissions, and the in-band emissions requirements) and indicate the greatest MPR value of the various MPR values to the UE, ensuring that any relevant emissions requirements are satisfied.

By performing the described techniques, devices (e.g., a UE and an NE) in a wireless communications system may provide for improved cell coverage for higher-order modulations, increased system throughput, and enhanced power management for uplink transmissions. For example, the NE-based determination of MPR values that satisfy EVM requirements, described herein, may enable the UE to transmit at higher power levels when using modulations such as 64 QAM and 256 QAM, thereby extending the portion of the cell where these higher-order modulations may be used. Additionally, the techniques may support determination of the MPR value even when the advanced receiver at the NE is undefined or when the NE performs radiated measurements while the UE performs conductive measurements, enabling flexibility in receiver implementations without requiring standardization of the advanced receiver. The separation of MPR values for different emissions requirements (e.g., EVM requirements, coexistence emissions requirements, and in-band emissions requirements) may enable the NE to determine a maximum MPR value that satisfies any relevant emissions constraints while maximizing the transmission power available to the UE. Furthermore, the calibration procedure in which the NE instructs the UE to increase transmission power by steps until the EVM requirement is exceeded may enable per-UE optimization of the MPR value, accounting for variations in PA implementations such as APT, ET, and DPD. The described techniques may also support signaling of UE capabilities related to linearized transmission modes, enabling the NE to schedule transmissions based on the actual MPR needed by the UE rather than a worst-case MPR value defined for all UEs.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

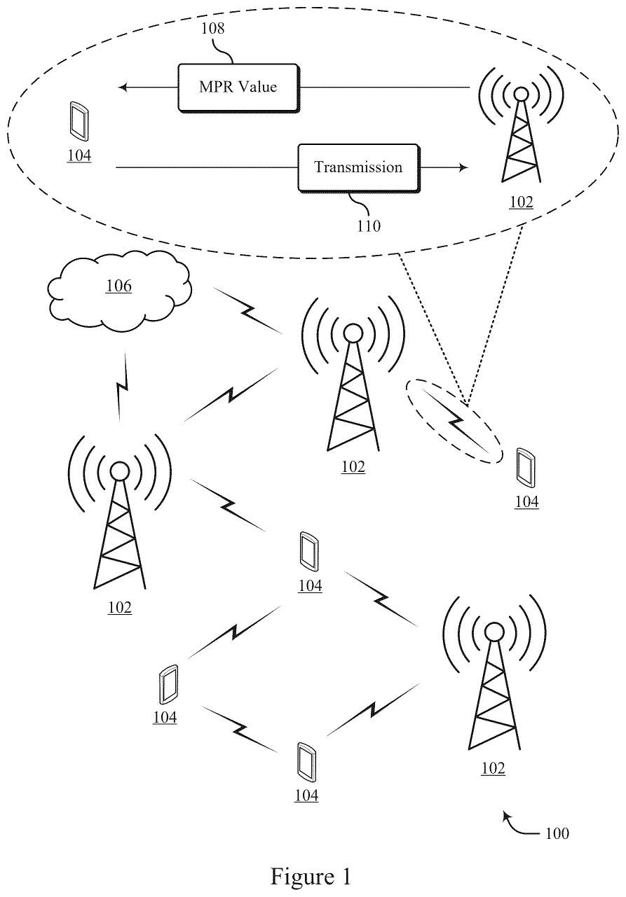

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NEs 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or a machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NEs 102 or the CN 106 through one or more backhaul links (e.g., S1, N2, N6, or other network interface). In some implementations, the NEs 102 may communicate with each other directly. In some other implementations, the NEs 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range (FR) designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the wireless communications system 100, a UE 104 may transmit signals to an NE 102 using various modulation schemes, including higher-order modulations such as 64 QAM and 256 QAM. Higher user and system throughput may be achieved when these higher-order modulation types are used over a larger portion of the cell coverage area of the NE 102 (e.g., where 64 QAM and 256 QAM correspond to 6 bits/symbol and 8 bits/symbol, respectively). The transmission power available for 64 QAM and 256 QAM may be limited by an EVM requirement. The EVM requirement may be relaxed through the use of an advanced receiver at the NE 102, enabling enhancement of the output power of the UE 104 and improvement of uplink coverage for higher-order modulation schemes.

The NE 102 may implement an advanced receiver configured to enable relaxation of the EVM requirement for the UE 104 without degrading uplink throughput. The advanced receiver may support reduced MPR values with relaxed transmit EVM requirements for higher-order modulation schemes including 64 QAM and 256 QAM. The advanced receiver may implement non-linearity models of transmission signals to capture PA non-linearity and other radio frequency (RF) impairments. In some examples, the advanced receiver may include a non-linear receiver such as a DPD receiver configured to estimate and invert the transmitter PA non-linearity of the UE 104.

For the UE 104, each modulation type may correspond to an MPR value that meets emissions requirements. Such emissions requirements may include one or more of co-existence emissions requirements, such as ACLR requirements, SEM requirements, and spurious emissions requirements, in-band emissions requirements, or EVM requirements. In-band emissions requirements may include one or more of limits on power transmitted in unallocated RBs, where the limit depends on a distance between the unallocated RB and a nearest allocated RB, local oscillator (LO) leakage, or in-phase/quadrature (I/Q) image power limits on RBs that are symmetrically located relative to an LO. In some cases, co-existence emissions requirements may be configured to protect users in other channels and bands. In some examples, the in-band emissions requirement may also be considered as primarily a co-existence emissions requirement that protects the RBs allocated to other UEs 104 by limiting interference from a transmitting UE 104 to other UEs 104. In some cases, the in-band emissions requirement related to I/Q image power limits may also be considered as a transmitter quality requirement.

The EVM requirement may be a measure of the quality of a transmitted signal from the UE 104. Different EVM requirements may be associated with different modulation types. For example, as shown in Table 1, the EVM requirements for different modulation types may include: Pi/2-BPSK at 30%, QPSK at 17.5%, 16QAM at 12.5%, 64 QAM at 8%, and 256 QAM at 3.5%.

TABLE 1
EVM Requirements

| Parameter | Unit | Average EVM Level |
|---|---|---|
| Pi/2-BPSK | % | 30 |
| QPSK | % | 17.5 |

| | | | |
|---|---|---|---|
| 16 | QAM | % | 12.5 |
| 64 | QAM | % | 8 |
| 256 | QAM | % | 3.5 |

The EVM may be a measure of the signal-to-noise ratio (SNR) of the transmitted signal. The EVM may be converted to SNR in dB according to the following equation.

$$SNR = 10 {log}_{10} {( \frac{1}{EVM / 100} )}^{2} .$$

For example, an EVM of 3.5% may correspond to an SNR of 29.1 dB. The signal-to-noise (SNR) ratio at the receiver of the NE 102 may not exceed an SNR corresponding to the EVM at the transmitter of the UE 104, given that the channel between the UE 104 and the NE 102 may exhibit time and frequency selective fading due to multipath propagation, and the receiver of the NE 102 may introduce additional impairments and thermal noise.

In some examples, MPR values may depend on both a power class of the UE 104 and a number of transmit antennas of a transmitter (e.g., the UE 104). In some cases, the MPR values may increase with modulation order, with the MPR values for 64 QAM and 256 QAM being the highest. For example, as shown in Table 2, for single antenna transmission with power class 3, the MPR for 256 QAM may be 6.5 dB and the MPR for 64 QAM may be 3.5 dB for CP-OFDM, independent of the allocation type. The MPR for an inner allocation of 16QAM may be 2 dB.

TABLE 2
MPR for Power Class 3

| | | MPR (dB) | | |
|---|---|---|---|---|
| | | Edge RB | Outer RB | Inner RB |
| Modulation | | allocations | allocations | allocations |
| DFT-s- | Pi/2 BPSK w/ | ≤3.5¹ | ≤1.2¹ | ≤0.2¹ |
| OFDM | Rel-15 DMRS | ≤0.5² | ≤0.5² | 0² |
| | Pi/2 BPSK w | ≤0.5² | 0² | 0² |
| | Pi/2 BPSK DMRS | | | |

| | QPSK | | ≤1 | 0 |
|---|---|---|---|---|
| | 16 | QAM | ≤2 | <1 |
| | 64 | QAM | ≤2.5 | |
| | 256 | QAM | ≤4.5 | |
| CP- | QPSK | | ≤3 | ≤1.5 |
| OFDM | 16 | QAM | ≤3 | ≤2 |

| | | |
|---|---|---|
| 64 | QAM | ≤3.5 |
| 256 | QAM | ≤6.5 |

NOTE 1:
Applicable for UE operating in TDD mode with Pi/2 BPSK modulation and UE indicates support for UE capability powerBoosting-pi2BPSK and if the IE powerBoostPi2BPSK is set to 1 and 40% or less slots in radio frame are used for UL transmission for bands n40, n41, n77, n78, and n79. The reference power of 0 dB MPR is 26 dBm.
NOTE 2:
Applicable for conditions where note 1 does not apply.

The need to increase the MPR for 64 QAM and 256 QAM may be based on the EVM requirement. When the EVM requirement is relaxed, the MPR may be reduced, enabling 64 QAM and 256 QAM to be used over a larger portion of the cell coverage area of the NE 102. In some implementations, a measured EVM may depend on both a transmission mode at the UE 104 and a receiver (e.g., of the NE 102) used to define the EVM. Receivers may be defined for measuring EVM for various transmission modes, including single antenna transmission, transmit diversity, and multiple-input multiple-output (MIMO) transmission. In some cases, separate receivers for measuring EVM may be defined for FR1 and FR2, as conductive testing may not be possible for FR2.

For single antenna transmission, the receiver used to define EVM may depend on the modulation type, including CP-OFDM or discrete Fourier transform spread OFDM (DFT-s-OFDM). The receiver may optimize sample timing and estimate and remove LO leakage. A fast Fourier transform (FFT) may be used to convert the received signal to the frequency domain, where an output of the FFT may be followed by equalization in the frequency domain. For CP-OFDM, the receiver may measure an EVM at this point and define the EVM as a percentage equal to 100 times the square root of the mean-squared error between the transmitted symbol and the demodulated symbol over the set of resource elements. For DFT-s-OFDM, the receiver may perform an inverse DFT before the EVM is measured, and the receiver may define the EVM as one hundred times the square root of the mean-squared error between the transmitted symbol and the demodulated symbol over the set of resource elements.

According to implementations, one or more of the NEs 102 and the UEs 104 are operable to implement various aspects of the techniques described with reference to the present disclosure. For example, a UE 104 and an NE 102 may support determination and indication of an MPR value based on an EVM requirement. Specifically, the NE 102 may determine an MPR value 108 for the UE 104 that satisfies an EVM requirement and transmit an indication of the MPR value 108 to the UE 104. In some examples, the MPR value 108 may be based on an MPR reduction, which may be applied for higher-order modulation schemes such as 64 QAM and 256 QAM when the NE 102 uses an advanced receiver. As described herein, the advanced receiver may be a receiver implementation at the NE 102 that differs from a reference receiver used for an existing (e.g., current) EVM definition. The described techniques enable the NE 102 to determine the MPR value 108 that satisfies the EVM requirement even if the advanced receiver is undefined. Additionally, the NE 102 may determine and indicate the MPR value 108 even if the NE 102 performs radiated measurements while the UE 104 performs a conductive measurement of the EVM. As the advanced receiver may not impact coexistence emissions requirements and in-band emissions requirements, the NE 102 may ensure that any reduction in the MPR still satisfies such emissions restraints. For example, the NE 102 may determine separate MPR values 108 for the different requirements (e.g., the EVM, the coexistence emissions, and the in-band emissions requirements) and indicate the greatest MPR value of the various MPR values to the UE 104, ensuring that any relevant emissions requirements are satisfied. The UE 104 may perform a transmission 110 using the indicated MPR value 108.

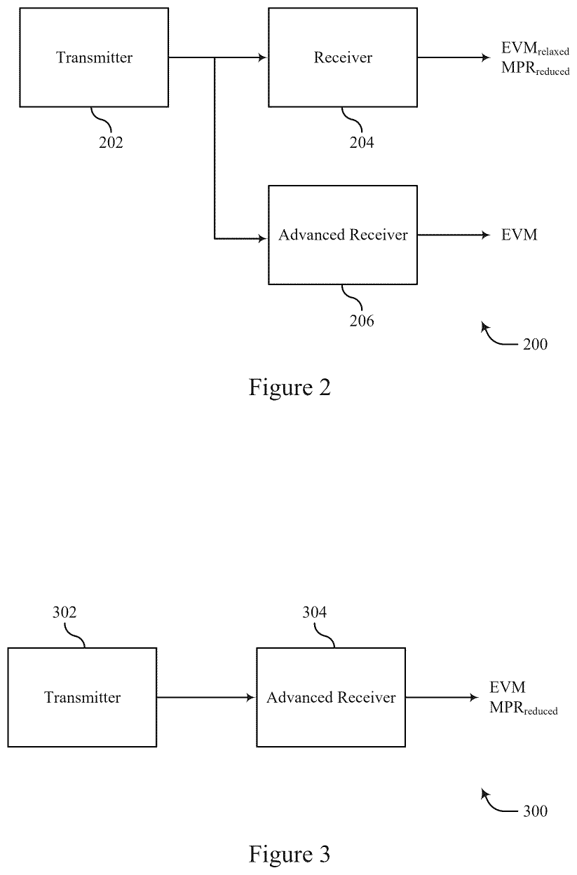

FIG. 2 illustrates an example of an MPR determination framework 200 in accordance with aspects of the present disclosure. The MPR determination framework 200 includes a transmitter 202, a receiver 204, and an advanced receiver 206. In some examples, the transmitter 202 may be associated with a UE 104, as described herein with reference to FIG. 1, while the receiver 204 and the advanced receiver 206 may be associated with an NE 102, as described herein with reference to FIG. 1. The transmitter 202 may generate and transmit signals to both the receiver 204 and the advanced receiver 206. The MPR determination framework 200 is an example of an indirect method for determining relaxed EVM and reduced MPR values, where the receiver 204 processes the signal using a reference receiver definition while the advanced receiver 206 processes the signal using enhanced reception capabilities.

In some implementations, the use of an advanced receiver 206 at the NE 102 may enable relaxation of transmitter EVM (Tx EVM) requirements for higher-order modulation schemes such as 64 QAM and 256 QAM. As described herein, the advanced receiver 206 may be a receiver implementation at the NE 102 that differs from a reference receiver used for an existing EVM definition. The NE 102 may use the reference receiver, such as the receiver 204, to define an EVM for each transmission mode and to determine the MPR allowed to meet the EVM requirement for each modulation type. In some examples, test equipment (e.g., at the NE-side) may use the receiver 204 to determine if the UE 104 meets the EVM requirement for the allowed MPR. Since the transmission power for 64 QAM and 256 QAM is primarily limited by Tx EVM requirements, relaxation of the Tx EVM requirements for such modulation schemes using the advanced receiver 206 may enable enhancement of UE output power and improvement of uplink coverage for higher-order modulations.

In some implementations, the advanced receiver 206 may signal, to the UE 104, an EVM relaxation for the existing EVM definition, which may allow or require the UE 104 to reduce its MPR for a given modulation type. From an implementation perspective, several considerations may arise with this approach. For example, the NE 102 may determine a mapping between the EVM requirement for the advanced receiver 206 and the EVM requirement for the reference receiver used to define EVM (e.g., the receiver 204). This mapping may be complicated by the fact that for FR1, EVM measurements may be conductive measurements performed at the UE antenna connectors, while the NE 102 may perform radiated measurements over the air interface. Additionally, the mapping may depend on a PA implementation of the UE 104, and a separate mapping may be required for each transmission mode.

In some implementations, the UE 104 may or may not know its own EVM value, or the UE 104 may only know that its EVM is at least as good as the EVM requirement. If the UE 104 receives an indication of an EVM relaxation, the UE 104 may determine the MPR or an MPR reduction that meets the new relaxed EVM. Additionally, the NE 102 may or may not know the MPR reduction corresponding to the EVM relaxation signaled to the UE 104, which may depend on the PA implementation at the UE 104. The UE 104 may signal the MPR reduction to enable the NE 102 to schedule and select an MCS for the UE 104.

According to the example of FIG. 2, the receiver 204 may receive a signal from the transmitter 202 and output a relaxed EVM value (e.g., indicating a relaxed EVM requirement) and a corresponding reduced MPR value. The advanced receiver 206 may also receive the transmitted signal from the transmitter 202 and output an EVM value. In this way, the MPR determination framework 200 is an example of an indirect method for determining the relaxed EVM and reduced MPR values, where the receiver 204 processes the signal using a reference receiver definition while the advanced receiver 206 processes the signal using enhanced reception capabilities. In some implementations, the MPR value determined using the MPR determination framework 200 may be a maximum of a set of MPR values that satisfy an emissions requirement and the EVM requirement, where the set of MPR values includes a first MPR value that satisfies the EVM requirement associated with the advanced receiver 206.

Based on the EVM measured at the output of the advanced receiver 206, the NE 102 may determine the relaxed EVM corresponding to the receiver 204 used for the existing EVM definition. The NE 102 may implement the receiver 204 and the advanced receiver 206 in parallel to determine a mapping between the EVM values for the two different receivers. However, the mapping observed by the NE 102 may be difficult to determine due to several factors. For example, for FR1, a conductive measurement may be used to define the EVM, where test equipment may be connected directly to antenna connectors at the UE 104 without a propagation channel between the UE 104 and the EVM measurement. Conversely, the NE 102 may only implement a radiated measurement over the wireless channel.

Additionally, the PA implementation of the UE 104 may influence the performance of the advanced receiver 206. The PA implementation may include methods used to linearize the PA and to reduce power consumption, including algorithms such as APT, ET, and DPD. APT may involve adjusting the PA supply voltage based on the average power level of the signal. ET may involve dynamically adjusting the PA supply voltage to track the envelope of the signal. DPD may involve applying a predistortion function to the input signal to compensate for PA nonlinearities. Different PA implementations across different UEs 104 may yield different mappings between the EVM at the output of the advanced receiver 206 and the EVM at the output of the receiver 204 used for the existing EVM definition. For multi-antenna transmission modes, the amount of coupling between the antennas may also affect the performance of the advanced receiver 206 and the mapping of the EVM at the output of the advanced receiver 206 to the relaxed EVM at the output of the receiver 204.

Due to such factors, the mapping between the EVM of the advanced receiver 206 and the relaxed EVM of the receiver 204 for the existing EVM definition may not be generalized. Even if the advanced receiver 206 is defined, it may be unlikely that a single mapping may apply between the EVM for the advanced receiver 206 and the relaxed EVM of the receiver 204, or between the relaxed EVM for the existing EVM definition and the maximum MPR allowed for the relaxed EVM value. As a result, the NE 102 may learn this mapping for each UE 104 through a calibration process. If the advanced receiver 206 is defined, a corresponding calibration process may be implemented in a factory setting. However, if the advanced receiver 206 is not specified and the NE 102 is allowed to choose its own advanced receiver implementation, the NE 102 may calibrate the UE 104 during online operation to determine the appropriate MPR value that satisfies the EVM requirement for the specific UE 104 and NE 102 combination.

FIG. 3 illustrates an example MPR determination framework 300 in accordance with aspects of the present disclosure. The MPR determination framework 300 includes a transmitter 302 and an advanced receiver 304. In some examples, the transmitter 302 may be associated with a UE 104, as described herein with reference to FIG. 1, while the advanced receiver 304 may be associated with an NE 102, as described herein with reference to FIG. 1. The transmitter 302 may generate and transmit signals to the advanced receiver 304. The MPR determination framework 300 is an example of a direct method for determining relaxed EVM and reduced MPR values, where the advanced receiver 304 processes signals using enhanced reception capabilities.

In some implementations, the advanced receiver 304 may be undefined in a specification. As the MPR allowed to meet relaxed EVM requirements may be reduced with the advanced receiver 304, the EVM requirement may no longer be the requirement that limits transmission power for 64 QAM and 256 QAM. To ensure that the ACLR, SEM, and spurious co-existence emissions requirements are still met when the MPR allowed for the EVM is reduced, separate MPR values may be defined for co-existence emissions requirements, in-band emissions requirements, and EVM requirements, at least for the case of some modulation schemes such as the 64 QAM and 256 QAM constellations. As used herein, a co-existence emissions requirement refers to emissions requirements configured to protect users in other channels and bands, including ACLR requirements, SEM requirements, and spurious emissions requirements. Additionally, as used herein, an in-band emissions requirement refers to requirements that limit interference to RBs allocated to other UEs, including limits on power transmitted in unallocated RBs, LO leakage, and I/Q image power limits. The separation of MPR values for different emissions requirements may be used because the NE 102 may be unable to evaluate ACLR, SEM, and spurious emissions from the UE 104. The MPR for such co-existence emissions requirements may be set independently of the receiver used to define the EVM as these co-existence emissions requirements do not depend on the receiver implementation.

By way of example, an MPR value, MPR_{coex}, may be defined for co-existence emissions requirements, and another MPR value, MPR_{EVM}, may be defined for EVM requirements. The value of MPR_{EVM} may depend on the advanced receiver 304 and a PA implementation at the UE 104. In some examples, MPR_{EVM} may denote the MPR allowed to meet the EVM requirement for the existing EVM receiver definition, where a different MPR value, MPR_{EVM-AR}, may denote an MPR allowed to meet the relaxed EVM requirement that applies when the NE uses the advanced receiver 304. From these definitions, it follows that MPR_{EVM-AR}≤MPR_{EVM}. The in-band emissions requirement can be included with the co-existence emissions requirements (e.g., ACLR, SEM, and spurious emissions requirements) when defining MPR_{coex}, or alternatively, a separate MPR_{in-band} may be defined to ensure that the in-band emissions requirements are satisfied. With these definitions, the allowed MPR that allows the UE 104 to meet any relevant emissions constraints with the existing EVM receiver definition may be given by MPR=max (MPR_{coex}, MPR_{in-band}, MPR_{EVM}), and with the advanced receiver EVM definition, the MPR allowed to meet any relevant emissions constraints may be given by MPR=max (MPR_{coex}, MPR_{in-band}, MPR_{EVM-AR}). In this manner, the MPR value may be a maximum of a set of MPR values that satisfy an emissions requirement and the EVM requirement, where the set of MPR values includes a first MPR value that satisfies the EVM requirement associated with an advanced receiver of the NE, a second MPR value that satisfies the co-existence emissions requirement, and a third MPR value that satisfies one or more in-band emissions requirements.

Alternatively, if the advanced EVM receiver definition is not standardized and is instead left to NE implementation, then the NE 102 may determine an MPR value in order for the UE 104 to meet the advanced receiver EVM requirement with online calibration. In some implementations, the MPR value may be based on an increase of a transmission power of the UE 104 until an EVM value exceeds the EVM requirement. The online calibration may be performed using a procedure in which the NE 102 may select a transmission mode for online calibration from a set including single antenna transmission, transmit diversity, or MIMO transmission. The NE 102 may select a modulation type (e.g., CP-OFDM or DFT-s-OFDM), an MCS associated with the selected modulation type (e.g., with a modulation order of pi/2-BPSK, QPSK, 16-QAM, 64-QAM, 256-QAM, 1024-QAM, or higher), and an inner RB allocation. The NE 102 may use an inner RB allocation to minimize the value of MPR_{coex} and maximize EVM MPR reduction by the advanced receiver 304 as much as possible, without being limited by the MPR required for coexistence. In this way, the NE 102 may transmit an indication of the transmission mode, the modulation type, the MCS, and the RB allocation to the UE 104, followed by an indication of a power reduction (e.g., an MPR reduction) to satisfy the EVM requirement based on the modulation type. The NE 102 may indicate the power reduction as an EVM MPR reduction ΔMPR_{EVM}, which may reduce the EVM MPR that the UE 104 may use to meet the EVM requirement to MPR_{EVM}-ΔMPR_{EVM}.

The NE 102 may transmit a power control command that instructs the UE 104 to increase a transmission power by steps in accordance with the MPR value and the EVM requirement. The UE 104 may increase the transmission power based on the power control command, and the NE 102 may determine whether the EVM requirement is satisfied in response to each step increase in the transmission power. The NE 102 may evaluate the modulation quality of the transmission received from the UE 104 using the advanced receiver 304 and determine whether the modulation quality is sufficient for the given modulation type. The NE 102 may evaluate the modulation quality using either an SNR at the output of the advanced receiver 304 or a decoded error rate. Based on the measured modulation quality, the NE 102 may take one of three actions. If the modulation quality is greater than or equal to a threshold, the NE 102 may signal a larger value of ΔMPR_{EVM} to the UE 104 and repeat the evaluation as described herein. If the modulation quality is less than or equal to a threshold, the NE 102 may signal a smaller value of ΔMPR_{EVM} to the UE 104 and repeat the evaluation as described herein. If the modulation quality is between the upper threshold and the lower threshold, then the NE 102 may set MPR_{EVM-AR}=MPR_{EVM}-ΔMPR_{EVM} and signal this value to the UE 104, completing the calibration for the given transmission mode and modulation constellation. In this manner, the NE 102 may evaluate the value MPR_{EVM-AR} for each UE 104, and at the end of the process, the NE 102 may signal the value of MPR_{EVM-AR} to the UE 104.

In some implementations, the advanced receiver 304 may be defined in a specification. Referring to the MPR determination framework 300 of FIG. 3, if the advanced receiver 304 used to relax the EVM requirement is specified, then MPR_{EVM-AR} may be defined as described herein, in the same manner as for the receiver used for the existing EVM requirement. Using the MPR determination framework 300, the NE 102 may use a direct method for determining the reduced MPR value for the advanced receiver 304, where the advanced receiver 304 directly evaluates the EVM and determines the corresponding MPR without requiring a mapping between different receiver definitions. For this direct approach, there is no need to generate a mapping between the EVM for the advanced receiver 304 (which is to satisfy the requirements described herein with reference to Table 1) and the corresponding relaxed EVM of the receiver used for an existing EVM requirement.

If the advanced receiver 304 is defined in the specification, the NE 102 may use two approaches to determine the corresponding MPR requirement for the UE. In some implementations, based on measurement or simulation, the specification may define an MPR that is allowed to meet the EVM requirement with the advanced receiver 304. The NE 102 may then signal, to the UE 104, whether the UE 104 should use the MPR that is allowed for the existing EVM definition, or whether the UE 104 should use a smaller MPR that is allowed for the EVM definition using the advanced receiver 304. The use of the advanced receiver 304 may be optional for the NE 102. In some examples, test equipment may be utilized to test the UE 104 to ensure that the UE 104 meets the EVM requirement with the advanced receiver 304 and the reduced MPR. If the UE 104 has a capability to meet the EVM requirement with the advanced receiver 304 and reduced MPR, the UE 104 may signal the capability to the NE 102. In some cases, such a capability may be mandatory for the UE 104.

In some implementations, test equipment may measure a power reduction needed by the UE 104 to meet the EVM requirement for the given modulation type rather than just reporting pass/fail for the MPR requirement. The test equipment may signal, to the UE 104, a transmission mode, a modulation type, an MCS associated with the modulation type, and an RB allocation. Initially, the test equipment may send power control commands instructing the UE 104 to maximize its transmission power subject to the allowed MPR for the existing EVM requirement. The test equipment may then instruct the UE 104 to increase its transmission power in steps. After each step increase in power, the test equipment may evaluate the EVM with the advanced receiver 304 and determine whether the EVM requirement is met. If the EVM requirement is met with the advanced receiver 304, then the test equipment may instruct the UE to increase the transmit power by another step. If the EVM is not met with the advanced receiver 304, the test equipment may record a maximum power for which the EVM requirement was met and report this value as MPR_{EVM}-AR. If there is only a single MPR value specified for meeting all emissions requirements for the advanced receiver 304, including co-existence emissions requirements (e.g., ACLR, SEM, spurious emissions requirements), in-band emissions requirements, and the EVM requirement, then MPR_{EVM-AR} may be sufficient to meet all of the applicable requirements. Thus, for a given transmit power, when the test equipment evaluates the EVM for the advanced receiver 304, the test equipment may also ensure that the co-existence and in-band emissions requirements are met.

In some implementations, the UE 104 may be configured to linearize a PA of the UE 104, and the NE 102 may determine and indicate an MPR value based on the linearization of the PA. In such cases, the linearization of a PA may refer to techniques that improve the linearity of the PA response, such as using more biasing power. A UE 104 that linearizes its PA by increasing power consumption may also use a lesser MPR to meet the EVM requirements, whether for an existing receiver and EVM definition or for an advanced receiver 304, as described herein. If the UE 104 is capable of linearizing its PA, the UE 104 may transmit an indication of a UE capability to satisfy the EVM requirement with the advanced receiver 304 and the MPR value. By linearizing the PA, the MPR to meet co-existence and in-band emissions requirements may also be reduced. The use of such a linearized mode of operation may depend on the battery status of the UE 104, which the UE 104 may signal to the NE 102.

In some examples, testing equipment may evaluate the MPR used to meet the co-existence emissions, in-band emissions, and EVM requirements during testing. Alternatively, if the UE 104 is to be characterized over-the-air to determine the MPR to meet the EVM requirement, then the test equipment may evaluate the MPR to meet co-existence emissions requirements and the in-band emissions requirements, MPR_{coex} and MPR_{in-band}, respectively, separately using conducted measurements since these emissions can only be evaluated at the UE 104 and not at the NE 102.

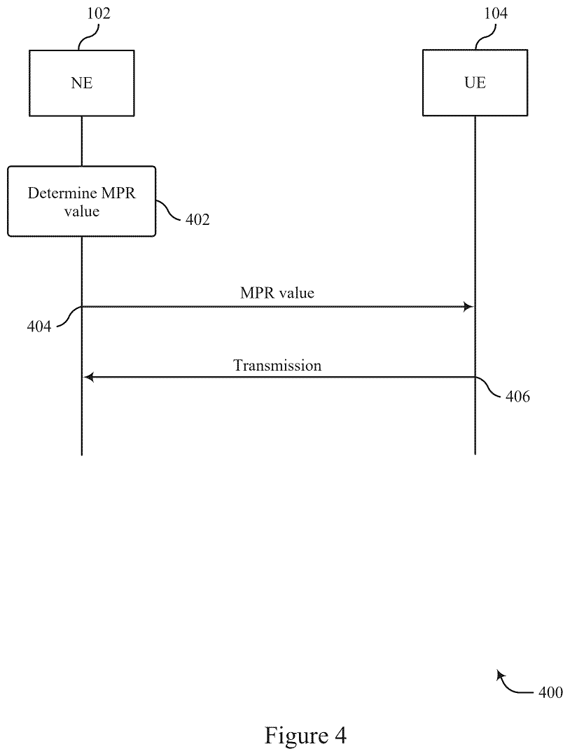

FIG. 4 illustrates an example of a signaling diagram 400 in accordance with aspects of the present disclosure. In some examples, the signaling diagram 400 implements or is implemented by aspects of the wireless communications system 100, the MPR determination framework 200, and the MPR determination framework 300. The signaling diagram 400 may implement or be implemented by an NE 102 and a UE 104, which may be examples of the corresponding devices as described with reference to FIGS. 1 through 3. Alternative examples of the following may be implemented, where some processes are performed in a different order than described or are not performed. In some cases, processes may include additional features not mentioned below, or further processes may be added.

At 402, the NE 102 determines an MPR value for the UE 104, where the MPR value satisfies an EVM requirement. In some examples, the MPR value is a maximum of a set of MPR values that satisfy an emissions requirement and the EVM requirement. The set of MPR values may include a first MPR value that satisfies the EVM requirement, where the first MPR value is associated with an advanced receiver of the NE 102. In some examples, the emissions requirement includes a co-existence emissions requirement, and the set of MPR values includes a second MPR value that satisfies the co-existence emissions requirement. In some examples, the emissions requirement includes one or more in-band emissions requirements, and the set of MPR values includes a third MPR value that satisfies the one or more in-band emissions requirements.

In some examples, the MPR value is based on an increase of a transmission power of the UE 104 until an EVM value exceeds the EVM requirement. The NE 102 may transmit an indication of a transmission mode, a modulation type, an MCS associated with the modulation type, and an RB allocation to the UE 104. In some cases, the modulation type may be one of CP-OFDM and DFT-s-OFDM, and a modulation order of the MCS may be one of pi/2-BPSK, QPSK, 16-QAM, 64-QAM, 256-QAM, 1024-QAM, or higher. The NE 102 may also transmit an indication of a power reduction to satisfy the EVM requirement, where the power reduction is based on the modulation type. The NE 102 may transmit a power control command that instructs the UE 104 to increase the transmission power by steps in accordance with the MPR value and the EVM requirement, and the NE 102 may determine whether the EVM requirement is satisfied in response to each step increase in the transmission power and determine the MPR value, where the MPR value corresponds to a maximum transmission power for which the EVM requirement is satisfied.

At 404, the NE 102 transmits an indication of the MPR value to the UE 104. In some examples, the UE 104 may transmit an indication of a UE capability to satisfy the EVM requirement with an advanced receiver of the NE 102 and the MPR value. The NE 102 may receive the indication of the UE capability and use this information for scheduling decisions and MPR determination.

In some examples, the UE 104 may linearize a PA of the UE 104, where the MPR value is based on the linearization of the PA. By linearizing the PA, the UE 104 may achieve reduced MPR values, enabling higher transmission power levels for higher-order modulations such as 64 QAM and 256 QAM.

At 406, the UE 104 performs a transmission using the MPR value. By using the MPR value determined by the NE 102, the UE 104 may transmit at optimized power levels that satisfy the EVM requirement while maximizing transmission power for improved cell coverage, particularly for higher-order modulations.

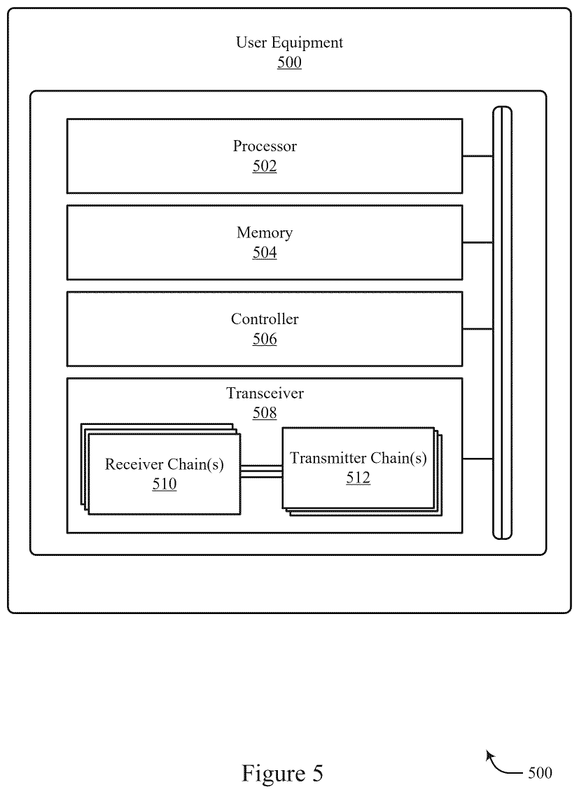

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions that, when executed by the processor 502, cause the UE 500 to perform various functions described herein. The code may be stored in a non-transitory computer-readable medium such as the memory 504 or another type of memory. Computer-readable media includes both non-transitory computer storage media and communication media, including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to or operable to support a means for receiving, from an NE, an indication of an MPR value, where the MPR value satisfies an EVM requirement, and performing a transmission using the MPR value. In this manner, the UE 500 supports improved cell coverage for higher-order modulations such as 64 QAM and 256 QAM by enabling transmissions at optimized power levels that satisfy EVM requirements, thereby increasing system throughput and extending the portion of the cell where these modulations may be used.

Additionally, the UE 500 may be configured to support any one or combination of the following. For example, the UE 500 may be configured to or operable to support where the MPR value is a maximum of a set of MPR values that satisfy an emissions requirement and the EVM requirement. This aspect ensures that any relevant emissions constraints are satisfied while maximizing the transmission power available to the UE 500, improving uplink coverage and throughput. Additionally, or alternatively, the UE 500 may be configured to or operable to support where the set of MPR values includes a first MPR value that satisfies the EVM requirement, the first MPR value associated with an advanced receiver of the NE. This aspect enables the UE 500 to benefit from enhanced receiver capabilities at the NE, allowing for reduced MPR values and increased transmission power when the NE employs advanced signal processing techniques. Additionally, or alternatively, the UE 500 may be configured to or operable to support where the emissions requirement includes a co-existence emissions requirement, and the set of MPR values includes a second MPR value that satisfies the co-existence emissions requirement. This aspect ensures protection of users in adjacent channels and bands while enabling optimized power management at the UE 500.

Additionally, or alternatively, the UE 500 may be configured to or operable to support where the emissions requirement includes one or more in-band emissions requirements, and the set of MPR values includes a third MPR value that satisfies the one or more in-band emissions requirements. This aspect limits interference to RBs allocated to other UEs, improving overall system reliability and spectral efficiency. Additionally, or alternatively, the UE 500 may be configured to or operable to support where the MPR value is based on an increase of a transmission power of the UE until an EVM value exceeds the EVM requirement. This aspect enables per-UE optimization of the MPR value, accounting for variations in PA implementations and maximizing transmission power for each specific UE. Additionally, or alternatively, the UE 500 may be configured to or operable to support receiving an indication of a transmission mode, a modulation type, an MCS associated with the modulation type, and an RB allocation, receiving an indication of a power reduction to satisfy the EVM requirement, the power reduction based on the modulation type, receiving a power control command that instructs the UE to increase the transmission power by steps in accordance with the MPR value and the EVM requirement, and increasing the transmission power based on the power control command. This aspect enables a calibration procedure that determines the optimal MPR value for the specific UE and NE combination, improving transmission efficiency and system performance.

Additionally, or alternatively, the UE 500 may be configured to or operable to support transmitting an indication of a UE capability to satisfy the EVM requirement with an advanced receiver of the NE and the MPR value. This aspect enables the NE to schedule transmissions based on the actual MPR needed by the UE 500, improving scheduling efficiency and system throughput. Additionally, or alternatively, the UE 500 may be configured to or operable to support linearizing a PA of the UE, where the MPR value is based on the linearization of the PA. This aspect enables the UE 500 to achieve reduced MPR values through enhanced PA linearity, further improving transmission power and cell coverage for higher-order modulations.

Additionally, or alternatively, the UE 500 may support at least one memory (e.g., the memory 504) and at least one processor (e.g., the processor 502) coupled with the at least one memory and configured to cause the UE to receive, from an NE, an indication of an MPR value, where the MPR value satisfies an EVM requirement, and perform a transmission using the MPR value. In this manner, the UE 500 supports improved cell coverage for higher-order modulations such as 64 QAM and 256 QAM by enabling transmissions at optimized power levels that satisfy EVM requirements, thereby increasing system throughput and extending the portion of the cell where these modulations may be used.

Additionally, the UE 500 may be configured to support any one or combination of the following. For example, the UE 500 may be configured to or operable to support where the MPR value is a maximum of a set of MPR values that satisfy an emissions requirement and the EVM requirement. This aspect ensures that any relevant emissions constraints are satisfied while maximizing the transmission power available to the UE 500, improving uplink coverage and throughput. Additionally, or alternatively, the UE 500 may be configured to or operable to support where the set of MPR values includes a first MPR value that satisfies the EVM requirement, the first MPR value associated with an advanced receiver of the NE. This aspect enables the UE 500 to benefit from enhanced receiver capabilities at the NE, allowing for reduced MPR values and increased transmission power when the NE employs advanced signal processing techniques. Additionally, or alternatively, the UE 500 may be configured to or operable to support where the emissions requirement includes a co-existence emissions requirement, and the set of MPR values includes a second MPR value that satisfies the co-existence emissions requirement. This aspect ensures protection of users in adjacent channels and bands while enabling optimized power management at the UE 500.

Additionally, or alternatively, the UE 500 may be configured to or operable to support where the emissions requirement includes one or more in-band emissions requirements, and the set of MPR values includes a third MPR value that satisfies the one or more in-band emissions requirements. This aspect limits interference to RBs allocated to other UEs, improving overall system reliability and spectral efficiency. Additionally, or alternatively, the UE 500 may be configured to or operable to support where the MPR value is based on an increase of a transmission power of the UE until an EVM value exceeds the EVM requirement. This aspect enables per-UE optimization of the MPR value, accounting for variations in PA implementations and maximizing transmission power for each specific UE. Additionally, or alternatively, the UE 500 may be configured to or operable to support receiving an indication of a transmission mode, a modulation type, an MCS associated with the modulation type, and an RB allocation, receiving an indication of a power reduction to satisfy the EVM requirement, the power reduction based on the modulation type, receiving a power control command that instructs the UE to increase the transmission power by steps in accordance with the MPR value and the EVM requirement, and increasing the transmission power based on the power control command. This aspect enables a calibration procedure that determines the optimal MPR value for the specific UE and NE combination, improving transmission efficiency and system performance.

Additionally, or alternatively, the UE 500 may be configured to or operable to support transmitting an indication of a UE capability to satisfy the EVM requirement with an advanced receiver of the NE and the MPR value. This aspect enables the NE to schedule transmissions based on the actual MPR needed by the UE 500, improving scheduling efficiency and system throughput. Additionally, or alternatively, the UE 500 may be configured to or operable to support linearizing a PA of the UE, where the MPR value is based on the linearization of the PA. This aspect enables the UE 500 to achieve reduced MPR values through enhanced PA linearity, further improving transmission power and cell coverage for higher-order modulations.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one PA configured to amplify the modulated signal to an appropriate power level suitable for transmission over the wireless medium. The transmitter chain 512 may also include one or more antennas for transmitting the amplified signal into the air or wireless medium.

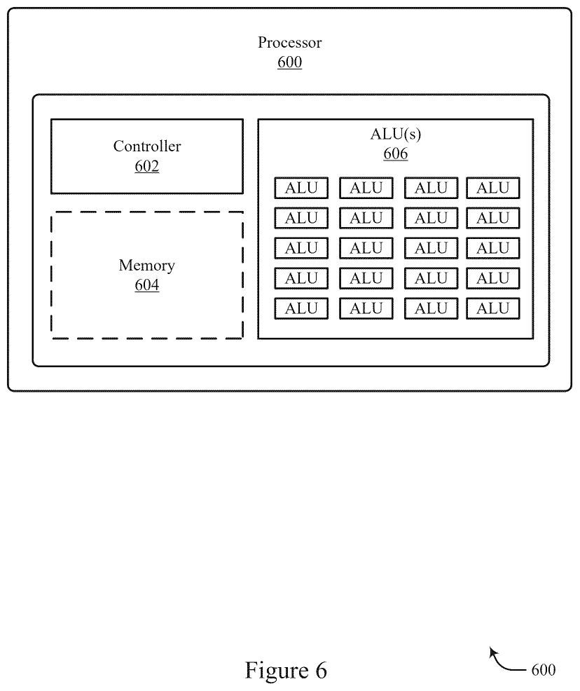

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory addresses of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage the flow of data within the processor 600. The controller 602 may be configured to control the transfer of data between registers, ALUs 606, and other functional units of the processor 600.

The memory 604 may include one or more caches (e.g., memory local to or included in the processor 600 or other memory, such as RAM, ROM, DRAM, SDRAM, SRAM, MRAM, flash memory, etc.). In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, and the controller 602, and may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 may be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support at least one controller (e.g., the controller 602) coupled with at least one memory (e.g., the memory 604) and configured to cause the processor to receive, from an NE, an indication of an MPR value, where the MPR value satisfies an EVM requirement, and perform a transmission using the MPR value. In this manner, the processor 600 supports improved cell coverage for higher-order modulations such as 64 QAM and 256 QAM by enabling transmissions at optimized power levels that satisfy EVM requirements, thereby increasing system throughput and extending the portion of the cell where these modulations may be used.

Additionally, the processor 600 may be configured to support any one or combination of the following. For example, the processor 600 may be configured to or operable to support where the MPR value is a maximum of a set of MPR values that satisfy an emissions requirement and the EVM requirement. This aspect ensures that any relevant emissions constraints are satisfied while maximizing the transmission power available to the processor 600, improving uplink coverage and throughput. Additionally, or alternatively, the processor 600 may be configured to or operable to support where the set of MPR values includes a first MPR value that satisfies the EVM requirement, the first MPR value associated with an advanced receiver of the NE. This aspect enables the processor 600 to benefit from enhanced receiver capabilities at the NE, allowing for reduced MPR values and increased transmission power when the NE employs advanced signal processing techniques. Additionally, or alternatively, the processor 600 may be configured to or operable to support where the emissions requirement includes a co-existence emissions requirement, and the set of MPR values includes a second MPR value that satisfies the co-existence emissions requirement. This aspect ensures protection of users in adjacent channels and bands while enabling optimized power management at the processor 600.

Additionally, or alternatively, the processor 600 may be configured to or operable to support where the emissions requirement includes one or more in-band emissions requirements, and the set of MPR values includes a third MPR value that satisfies the one or more in-band emissions requirements. This aspect limits interference to RBs allocated to other UEs, improving overall system reliability and spectral efficiency. Additionally, or alternatively, the processor 600 may be configured to or operable to support where the MPR value is based on an increase of a transmission power of the UE until an EVM value exceeds the EVM requirement. This aspect enables per-UE optimization of the MPR value, accounting for variations in PA implementations and maximizing transmission power for each specific processor 600. Additionally, or alternatively, the processor 600 may be configured to or operable to support receiving an indication of a transmission mode, a modulation type, an MCS associated with the modulation type, and an RB allocation, receiving an indication of a power reduction to satisfy the EVM requirement, the power reduction based on the modulation type, receiving a power control command that instructs the UE to increase the transmission power by steps in accordance with the MPR value and the EVM requirement, and increasing the transmission power based on the power control command. This aspect enables a calibration procedure that determines the optimal MPR value for the specific processor 600 and NE combination, improving transmission efficiency and system performance.

Additionally, or alternatively, the processor 600 may be configured to or operable to support transmitting an indication of a UE capability to satisfy the EVM requirement with an advanced receiver of the NE and the MPR value. This aspect enables the NE to schedule transmissions based on the actual MPR needed by the processor 600, improving scheduling efficiency and system throughput. Additionally, or alternatively, the processor 600 may be configured to or operable to support linearizing a PA of the UE, where the MPR value is based on the linearization of the PA. This aspect enables the processor 600 to achieve reduced MPR values through enhanced PA linearity, further improving transmission power and cell coverage for higher-order modulations.

Additionally, or alternatively, the processor 600 may support at least one memory (e.g., the memory 504) and at least one processor (e.g., the processor 502) coupled with the at least one memory and configured to cause the UE to receive, from an NE, an indication of an MPR value, where the MPR value satisfies an EVM requirement, and perform a transmission using the MPR value. In this manner, the processor 600 supports improved cell coverage for higher-order modulations such as 64 QAM and 256 QAM by enabling transmissions at optimized power levels that satisfy EVM requirements, thereby increasing system throughput and extending the portion of the cell where these modulations may be used.

Additionally, the processor 600 may be configured to support any one or combination of the following. For example, the processor may be configured to or operable to support where the MPR value is a maximum of a set of MPR values that satisfy an emissions requirement and the EVM requirement. This aspect ensures that any relevant emissions constraints are satisfied while maximizing the transmission power available to the processor 600, improving uplink coverage and throughput. Additionally, or alternatively, the processor 600 may be configured to or operable to support where the set of MPR values includes a first MPR value that satisfies the EVM requirement, the first MPR value associated with an advanced receiver of the NE. This aspect enables the processor 600 to benefit from enhanced receiver capabilities at the NE, allowing for reduced MPR values and increased transmission power when the NE employs advanced signal processing techniques. Additionally, or alternatively, the processor 600 may be configured to or operable to support where the emissions requirement includes a co-existence emissions requirement, and the set of MPR values includes a second MPR value that satisfies the co-existence emissions requirement. This aspect ensures protection of users in adjacent channels and bands while enabling optimized power management at the processor 600.

Additionally, or alternatively, the processor 600 may be configured to or operable to support where the emissions requirement includes one or more in-band emissions requirements, and the set of MPR values includes a third MPR value that satisfies the one or more in-band emissions requirements. This aspect limits interference to RBs allocated to other UEs, improving overall system reliability and spectral efficiency. Additionally, or alternatively, the processor 600 may be configured to or operable to support where the MPR value is based on an increase of a transmission power of the UE until an EVM value exceeds the EVM requirement. This aspect enables per-UE optimization of the MPR value, accounting for variations in PA implementations and maximizing transmission power for each specific processor 600. Additionally, or alternatively, the processor 600 may be configured to or operable to support receiving an indication of a transmission mode, a modulation type, an MCS associated with the modulation type, and an RB allocation, receiving an indication of a power reduction to satisfy the EVM requirement, the power reduction based on the modulation type, receiving a power control command that instructs the UE to increase the transmission power by steps in accordance with the MPR value and the EVM requirement, and increasing the transmission power based on the power control command. This aspect enables a calibration procedure that determines the optimal MPR value for the specific processor 600 and NE combination, improving transmission efficiency and system performance.

Additionally, or alternatively, the processor 600 may be configured to or operable to support transmitting an indication of a UE capability to satisfy the EVM requirement with an advanced receiver of the NE and the MPR value. This aspect enables the NE to schedule transmissions based on the actual MPR needed by the processor 600, improving scheduling efficiency and system throughput. Additionally, or alternatively, the processor 600 may be configured to or operable to support linearizing a PA of the UE, where the MPR value is based on the linearization of the PA. This aspect enables the processor 600 to achieve reduced MPR values through enhanced PA linearity, further improving transmission power and cell coverage for higher-order modulations.

Additionally, or alternatively, the processor 600 may support wireless communication in accordance with examples as disclosed herein. The processor 600 may be configured to or operable to support at least one controller (e.g., the controller 602) coupled with at least one memory (e.g., the memory 604) and configured to cause the processor 600 to determine an MPR value for a UE, where the MPR value satisfies an EVM requirement, and transmit, to the UE, an indication of the MPR value. In this manner, the NE 700 supports improved cell coverage for higher-order modulations such as 64 QAM and 256 QAM by enabling transmissions at optimized power levels that satisfy EVM requirements, thereby increasing system throughput and extending the portion of the cell where these modulations may be used.

Additionally, or alternatively, the processor 600 may be configured to or operable to support any one or combination of the following. For example, the processor 600 may be configured to or operable to support where the MPR value is a maximum of a set of MPR values that satisfy an emissions requirement and the EVM requirement. This aspect ensures that any relevant emissions constraints are satisfied while maximizing the transmission power available to the UE, improving uplink coverage and throughput. Additionally, or alternatively, the processor 600 may be configured to or operable to support where the set of MPR values includes a first MPR value that satisfies the EVM requirement, the first MPR value associated with an advanced receiver of the NE. This aspect enables the processor 600 to leverage enhanced receiver capabilities, allowing for reduced MPR values and increased transmission power when the NE employs advanced signal processing techniques. Additionally, or alternatively, the processor 600 may be configured to or operable to support where the emissions requirement includes a co-existence emissions requirement, and the set of MPR values includes a second MPR value that satisfies the co-existence emissions requirement. This aspect ensures protection of users in adjacent channels and bands while enabling optimized power management.

Additionally, or alternatively, the processor 600 may be configured to or operable to support where the emissions requirement includes one or more in-band emissions requirements, and the set of MPR values includes a third MPR value that satisfies the one or more in-band emissions requirements. This aspect limits interference to RBs allocated to other UEs, improving overall system reliability and spectral efficiency. Additionally, or alternatively, the processor 600 may be configured to or operable to support determining the MPR value by increasing a transmit power of the UE and measuring an EVM value until the EVM value exceeds the EVM requirement. This aspect enables per-UE optimization of the MPR value, accounting for variations in PA implementations and maximizing transmission power for each specific UE. Additionally, or alternatively, the processor 600 may be configured to or operable to support where the MPR value is associated with an advanced receiver of the NE, and to determine the MPR value by selecting a transmission mode, selecting a modulation type, an MCS associated with the modulation type, and an RB allocation, transmitting, to the UE, an indication of the transmission mode, the modulation type, the MCS, and the RB allocation, transmitting, to the UE, an indication of a power reduction to satisfy the EVM requirement based on the modulation type, transmitting, to the UE, a power control command that instructs the UE to increase a transmission power by steps in accordance with the MPR value and the EVM requirement, determining whether the EVM requirement is satisfied in response to each step increase in the transmission power, and determining the MPR value, where the MPR value corresponds to a maximum transmission power for which the EVM requirement is satisfied. This aspect enables a calibration procedure that determines the optimal MPR value for the specific UE and NE combination, improving transmission efficiency and system performance.

Additionally, or alternatively, the processor 600 may be configured to or operable to support receiving an indication of a UE capability to satisfy the EVM requirement with an advanced receiver of the NE and the MPR value. This aspect enables the processor 600 to schedule transmissions based on the actual MPR needed by the UE, improving scheduling efficiency and system throughput. Additionally, or alternatively, the processor 600 may be configured to or operable to support where the MPR value is determined based on a linearization of a PA of the UE. This aspect enables the processor 600 to account for enhanced PA linearity at the UE, further improving transmission power and cell coverage for higher-order modulations.

Additionally, or alternatively, the processor 600 may support at least one memory (e.g., the memory 704) and at least one processor (e.g., the processor 702) coupled with the at least one memory and configured to cause the NE to determine an MPR value for a UE, where the MPR value satisfies an EVM requirement, and transmit, to the UE, an indication of the MPR value. In this manner, the processor 600 supports improved cell coverage for higher-order modulations such as 64 QAM and 256 QAM by enabling transmissions at optimized power levels that satisfy EVM requirements, thereby increasing system throughput and extending the portion of the cell where these modulations may be used.

Additionally, or alternatively, the processor 600 may be configured to support any one or a combination of where the MPR value is a maximum of a set of MPR values that satisfy an emissions requirement and the EVM requirement. This aspect ensures that any relevant emissions constraints are satisfied while maximizing the transmission power available to the UE, improving uplink coverage and throughput. Additionally, or alternatively, the processor 600 may be configured to or operable to support where the set of MPR values includes a first MPR value that satisfies the EVM requirement, the first MPR value associated with an advanced receiver of the NE. This aspect enables the processor 600 to leverage enhanced receiver capabilities, allowing for reduced MPR values and increased transmission power when the NE employs advanced signal processing techniques. Additionally, or alternatively, the processor 600 may be configured to or operable to support where the emissions requirement includes a co-existence emissions requirement, and the set of MPR values includes a second MPR value that satisfies the co-existence emissions requirement. This aspect ensures protection of users in adjacent channels and bands while enabling optimized power management.

Additionally, or alternatively, the processor 600 may be configured to or operable to support where the emissions requirement includes one or more in-band emissions requirements, and the set of MPR values includes a third MPR value that satisfies the one or more in-band emissions requirements. This aspect limits interference to RBs allocated to other UEs, improving overall system reliability and spectral efficiency. Additionally, or alternatively, the processor 600 may be configured to or operable to support determining the MPR value by increasing a transmit power of the UE and measuring an EVM value until the EVM value exceeds the EVM requirement. This aspect enables per-UE optimization of the MPR value, accounting for variations in PA implementations and maximizing transmission power for each specific UE. Additionally, or alternatively, the processor 600 may be configured to or operable to support where the MPR value is associated with an advanced receiver of the NE, and to determine the MPR value by selecting a transmission mode, selecting a modulation type, an MCS associated with the modulation type, and an RB allocation, transmitting, to the UE, an indication of the transmission mode, the modulation type, the MCS, and the RB allocation, transmitting, to the UE, an indication of a power reduction to satisfy the EVM requirement based on the modulation type, transmitting, to the UE, a power control command that instructs the UE to increase a transmission power by steps in accordance with the MPR value and the EVM requirement, determining whether the EVM requirement is satisfied in response to each step increase in the transmission power, and determining the MPR value, where the MPR value corresponds to a maximum transmission power for which the EVM requirement is satisfied. This aspect enables a calibration procedure that determines the optimal MPR value for the specific UE and NE combination, improving transmission efficiency and system performance.

Additionally, or alternatively, the processor 600 may be configured to or operable to support receiving an indication of a UE capability to satisfy the EVM requirement with an advanced receiver of the NE and the MPR value. This aspect enables the processor 600 to schedule transmissions based on the actual MPR needed by the UE, improving scheduling efficiency and system throughput. Additionally, or alternatively, the processor 600 may be configured to or operable to support where the MPR value is determined based on a linearization of a PA of the UE. This aspect enables the processor 600 to account for enhanced PA linearity at the UE, further improving transmission power and cell coverage for higher-order modulations.

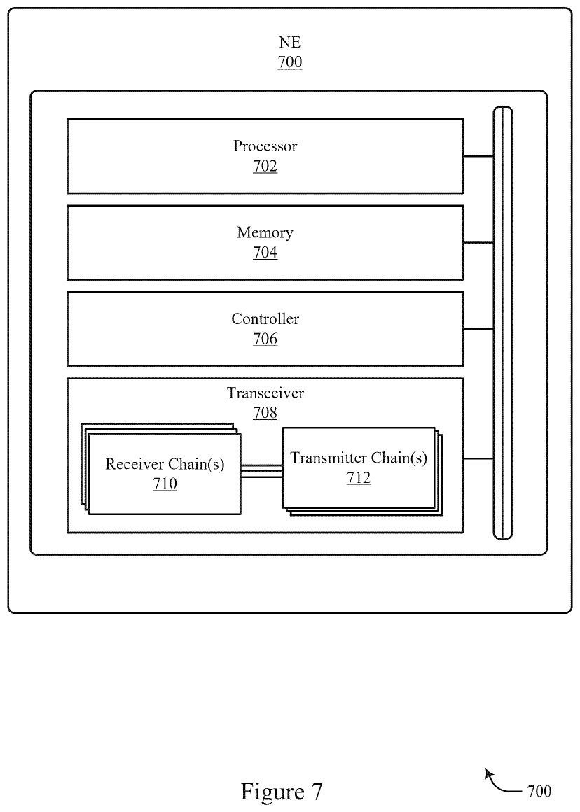

FIG. 7 illustrates an example of an NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to or operable to support a means for determining an MPR value for a UE, where the MPR value satisfies an EVM requirement, and transmitting, to the UE, an indication of the MPR value. In this manner, the NE 700 supports improved cell coverage for higher-order modulations such as 64 QAM and 256 QAM by enabling transmissions at optimized power levels that satisfy EVM requirements, thereby increasing system throughput and extending the portion of the cell where these modulations may be used.

Additionally, the NE 700 may be configured to or operable to support any one or combination of the following. For example, the NE 700 may be configured to or operable to support where the MPR value is a maximum of a set of MPR values that satisfy an emissions requirement and the EVM requirement. This aspect ensures that any relevant emissions constraints are satisfied while maximizing the transmission power available to the UE, improving uplink coverage and throughput. Additionally, or alternatively, the NE 700 may be configured to or operable to support where the set of MPR values includes a first MPR value that satisfies the EVM requirement, the first MPR value associated with an advanced receiver of the NE. This aspect enables the NE 700 to leverage enhanced receiver capabilities, allowing for reduced MPR values and increased transmission power when the NE employs advanced signal processing techniques. Additionally, or alternatively, the NE 700 may be configured to or operable to support where the emissions requirement includes a co-existence emissions requirement, and the set of MPR values includes a second MPR value that satisfies the co-existence emissions requirement. This aspect ensures protection of users in adjacent channels and bands while enabling optimized power management.

Additionally, or alternatively, the NE 700 may be configured to or operable to support where the emissions requirement includes one or more in-band emissions requirements, and the set of MPR values includes a third MPR value that satisfies the one or more in-band emissions requirements. This aspect limits interference to RBs allocated to other UEs, improving overall system reliability and spectral efficiency. Additionally, or alternatively, the NE 700 may be configured to or operable to support determining the MPR value by increasing a transmit power of the UE and measuring an EVM value until the EVM value exceeds the EVM requirement. This aspect enables per-UE optimization of the MPR value, accounting for variations in PA implementations and maximizing transmission power for each specific UE. Additionally, or alternatively, the NE 700 may be configured to or operable to support where the MPR value is associated with an advanced receiver of the NE, and to determine the MPR value by selecting a transmission mode, selecting a modulation type, an MCS associated with the modulation type, and an RB allocation, transmitting, to the UE, an indication of the transmission mode, the modulation type, the MCS, and the RB allocation, transmitting, to the UE, an indication of a power reduction to satisfy the EVM requirement based on the modulation type, transmitting, to the UE, a power control command that instructs the UE to increase a transmission power by steps in accordance with the MPR value and the EVM requirement, determining whether the EVM requirement is satisfied in response to each step increase in the transmission power, and determining the MPR value, where the MPR value corresponds to a maximum transmission power for which the EVM requirement is satisfied. This aspect enables a calibration procedure that determines the optimal MPR value for the specific UE and NE combination, improving transmission efficiency and system performance.

Additionally, or alternatively, the NE 700 may be configured to or operable to support receiving an indication of a UE capability to satisfy the EVM requirement with an advanced receiver of the NE and the MPR value. This aspect enables the NE 700 to schedule transmissions based on the actual MPR needed by the UE, improving scheduling efficiency and system throughput. Additionally, or alternatively, the NE 700 may be configured to or operable to support where the MPR value is determined based on a linearization of a PA of the UE. This aspect enables the NE 700 to account for enhanced PA linearity at the UE, further improving transmission power and cell coverage for higher-order modulations.

Additionally, or alternatively, the NE 700 may support at least one memory (e.g., the memory 704) and at least one processor (e.g., the processor 702) coupled with the at least one memory and configured to cause the NE to determine an MPR value for a UE, where the MPR value satisfies an EVM requirement, and transmit, to the UE, an indication of the MPR value. In this manner, the NE 700 supports improved cell coverage for higher-order modulations such as 64 QAM and 256 QAM by enabling transmissions at optimized power levels that satisfy EVM requirements, thereby increasing system throughput and extending the portion of the cell where these modulations may be used.

Additionally, the NE 700 may be configured to support any one or combination of where the MPR value is a maximum of a set of MPR values that satisfy an emissions requirement and the EVM requirement. This aspect ensures that any relevant emissions constraints are satisfied while maximizing the transmission power available to the UE, improving uplink coverage and throughput. Additionally, or alternatively, the NE 700 may be configured to or operable to support where the set of MPR values includes a first MPR value that satisfies the EVM requirement, the first MPR value associated with an advanced receiver of the NE. This aspect enables the NE 700 to leverage enhanced receiver capabilities, allowing for reduced MPR values and increased transmission power when the NE employs advanced signal processing techniques. Additionally, or alternatively, the NE 700 may be configured to or operable to support where the emissions requirement includes a co-existence emissions requirement, and the set of MPR values includes a second MPR value that satisfies the co-existence emissions requirement. This aspect ensures protection of users in adjacent channels and bands while enabling optimized power management.

Additionally, or alternatively, the NE 700 may be configured to or operable to support where the emissions requirement includes one or more in-band emissions requirements, and the set of MPR values includes a third MPR value that satisfies the one or more in-band emissions requirements. This aspect limits interference to RBs allocated to other UEs, improving overall system reliability and spectral efficiency. Additionally, or alternatively, the NE 700 may be configured to or operable to support determining the MPR value by increasing a transmit power of the UE and measuring an EVM value until the EVM value exceeds the EVM requirement. This aspect enables per-UE optimization of the MPR value, accounting for variations in PA implementations and maximizing transmission power for each specific UE. Additionally, or alternatively, the NE 700 may be configured to or operable to support where the MPR value is associated with an advanced receiver of the NE, and to determine the MPR value by selecting a transmission mode, selecting a modulation type, an MCS associated with the modulation type, and an RB allocation, transmitting, to the UE, an indication of the transmission mode, the modulation type, the MCS, and the RB allocation, transmitting, to the UE, an indication of a power reduction to satisfy the EVM requirement based on the modulation type, transmitting, to the UE, a power control command that instructs the UE to increase a transmission power by steps in accordance with the MPR value and the EVM requirement, determining whether the EVM requirement is satisfied in response to each step increase in the transmission power, and determining the MPR value, where the MPR value corresponds to a maximum transmission power for which the EVM requirement is satisfied. This aspect enables a calibration procedure that determines the optimal MPR value for the specific UE and NE combination, improving transmission efficiency and system performance.

Additionally, or alternatively, the NE 700 may be configured to or operable to support receiving an indication of a UE capability to satisfy the EVM requirement with an advanced receiver of the NE and the MPR value. This aspect enables the NE 700 to schedule transmissions based on the actual MPR needed by the UE, improving scheduling efficiency and system throughput. Additionally, or alternatively, the NE 700 may be configured to or operable to support where the MPR value is determined based on a linearization of a PA of the UE. This aspect enables the NE 700 to account for enhanced PA linearity at the UE, further improving transmission power and cell coverage for higher-order modulations.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one PA configured to amplify the modulated signal to an appropriate power level suitable for transmission over the wireless medium. The transmitter chain 712 may also include one or more antennas for transmitting the amplified signal into the air or wireless medium.

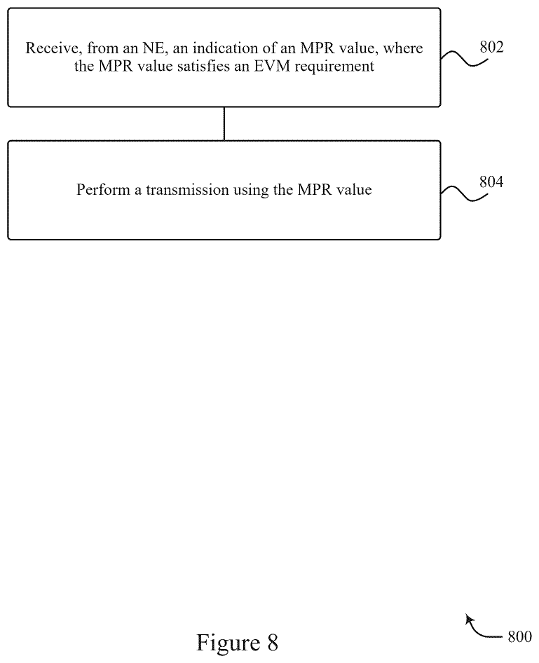

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 802, the method may include receiving, from an NE, an indication of an MPR value, where the MPR value satisfies an EVM requirement. The operations of 802 may be performed in accordance with examples as described herein. In some implementations, aspects of the operations of 802 may be performed by a UE as described with reference to FIG. 5.

At 804, the method may include performing a transmission using the MPR value. The operations of 804 may be performed in accordance with examples as described herein. In some implementations, aspects of the operations of 804 may be performed by a UE as described with reference to FIG. 5.

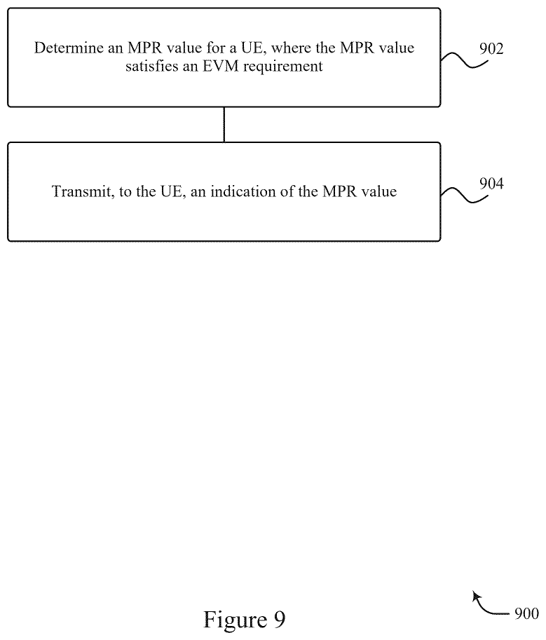

FIG. 9 illustrates a flowchart of a method 900 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 902, the method may include determining an MPR value for a UE, where the MPR value satisfies an EVM requirement. The operations of 902 may be performed in accordance with examples as described herein. In some implementations, aspects of the operations of 902 may be performed by an NE as described with reference to FIG. 7.

At 904, the method may include transmitting, to the UE, an indication of the MPR value. The operations of 904 may be performed in accordance with examples as described herein. In some implementations, aspects of the operations of 904 may be performed by an NE as described with reference to FIG. 7.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive, from a network equipment (NE), an indication of a maximum power reduction (MPR) value, wherein the MPR value satisfies an error vector magnitude (EVM) requirement; and
perform a transmission using the MPR value.

2. The UE of claim 1, wherein the MPR value is a maximum of a set of MPR values that satisfy an emissions requirement and the EVM requirement.

3. The UE of claim 2, wherein the set of MPR values includes a first MPR value that satisfies the EVM requirement, the first MPR value associated with an advanced receiver of the NE.

4. The UE of claim 2, wherein the emissions requirement includes a co-existence emissions requirement, and wherein the set of MPR values includes a second MPR value that satisfies the co-existence emissions requirement.

5. The UE of claim 2, wherein the emissions requirement includes one or more in-band emissions requirements, and wherein the set of MPR values includes a third MPR value that satisfies the one or more in-band emissions requirements.

6. The UE of claim 1, wherein the MPR value is based at least in part on an increase of a transmission power of the UE until an EVM value exceeds the EVM requirement.

7. The UE of claim 6, wherein the at least one processor is further operable to cause the UE to:
receive an indication of a transmission mode, a modulation type, a modulation and coding scheme (MCS) associated with the modulation type, and a resource block (RB) allocation;
receive an indication of a power reduction to satisfy the EVM requirement, the power reduction based at least in part on the modulation type;
receive a power control command that instructs the UE to increase the transmission power by steps in accordance with the MPR value and the EVM requirement; and
increase the transmission power based at least in part on the power control command.

8. The UE of claim 1, wherein the at least one processor is further operable to cause the UE to transmit an indication of a UE capability to satisfy the EVM requirement with an advanced receiver of the NE and the MPR value.

9. The UE of claim 1, wherein the at least one processor is further operable to cause the UE to linearize a power amplifier (PA) of the UE, wherein the MPR value is based at least in part on the linearization of the PA.

10. A network equipment (NE) for wireless communication, comprising:
at least one memory; and
at least one processor coupled with the at least one memory and operable to cause the NE to:
determine a maximum power reduction (MPR) value for a user equipment (UE), wherein the MPR value satisfies an error vector magnitude (EVM) requirement; and
transmit, to the UE, an indication of the MPR value.

11. The NE of claim 10, wherein the MPR value is a maximum of a set of MPR values that satisfy an emissions requirement and the EVM requirement.

12. The NE of claim 11, wherein the set of MPR values includes a first MPR value that satisfies the EVM requirement, the first MPR value associated with an advanced receiver of the NE.

13. The NE of claim 11, wherein the emissions requirement includes a co-existence emissions requirement, and wherein the set of MPR values includes a second MPR value that satisfies the co-existence emissions requirement.

14. The NE of claim 11, wherein the emissions requirement includes one or more in-band emissions requirements, and wherein the set of MPR values includes a third MPR value that satisfies the one or more in-band emissions requirements.

15. The NE of claim 10, wherein, to determine the MPR value, the at least one processor is further operable to cause the NE to increase a transmit power of the UE and measure an EVM value until the EVM value exceeds the EVM requirement.

16. The NE of claim 10, wherein the MPR value is associated with an advanced receiver of the NE, and wherein, to determine the MPR value, the at least one processor is further operable to cause the NE to:
select a transmission mode;
select a modulation type, a modulation and coding scheme (MCS) associated with the modulation type, and a resource block (RB) allocation;
transmit, to the UE, an indication of the transmission mode, the modulation type, the MCS, and the RB allocation;
transmit, to the UE, an indication of a power reduction to satisfy the EVM requirement based at least in part on the modulation type;
transmit, to the UE, a power control command that instructs the UE to increase a transmission power by steps in accordance with the MPR value and the EVM requirement;
determine whether the EVM requirement is satisfied in response to each step increase in the transmission power; and
determine the MPR value, wherein the MPR value corresponds to a maximum transmission power for which the EVM requirement is satisfied.

17. The NE of claim 10, wherein the at least one processor is further operable to cause the NE to receive an indication of a UE capability to satisfy the EVM requirement with an advanced receiver of the NE and the MPR value.

18. The NE of claim 10, wherein the MPR value is determined based at least in part on a linearization of a power amplifier (PA) of the UE.

19. A method performed by a user equipment (UE), the method comprising:
receiving, from a network equipment (NE), an indication of a maximum power reduction (MPR) value, wherein the MPR value satisfies an error vector magnitude (EVM) requirement; and
performing a transmission using the MPR value.

20. A method performed by a network equipment (NE), the method comprising:
determining a maximum power reduction (MPR) value for a user equipment (UE), wherein the MPR value satisfies an error vector magnitude (EVM) requirement; and
transmitting, to the UE, an indication of the MPR value.
